(19) United States
(12) Patent Application Publication
(10) Pub. No.: US 2007/0226701 A1
(43) Pub. Date: Sep. 27, 2007

(54) Automated central trace management

(75) Inventors: Jukka Suonvieri, Teralahti (FI); Mervyn Graham, Tampere (FI); Gyula Bodog, Budapest (HU); Yin Yu, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/707,012

(22) Filed: Feb. 16, 2007

Related U.S. Application Data
(60) Provisional application No. 60/784,755, filed on Mar. 23, 2006.

(51) Int. Cl. G06F 9/44

(52) U.S. Cl. 717/128

(57) ABSTRACT

Automated central trace management in a communication network including a network managing entity and at least one subordinate network entity, comprising the steps of activating a trace session locally at the at least one subordinate network entity and emitting a notification of said activated trace session from the at least one subordinate network entity to the network managing entity.

### REFERENCE TO RELATED APPLICATIONS

This application claims priority of U.S. Provisional Patent Application Ser. No. 60/784,755, filed on Mar. 23, 2006, the contents of which are hereby incorporated by reference.

### FIELD OF THE INVENTION

The present invention relates to trace management in communication networks. In particular, the present invention relates to an automated central trace management for local trace activation in the network.

### BACKGROUND OF THE INVENTION

In the field of network management and particularly communication network management, there is known the concept of tracing. To, this end, traces for every object to be traced are established in the network, which may for example be a second generation network such as GSM (Global System for Mobile Communication) or a third generation network such as UMTS (Universal Mobile Telecommunication System) or CDMA (Code Division Multiple Access), or any intermediary network such as GPRS (General Packet Radio Service).

Objects to be traced may either be a subscriber or an equipment. Thus, it is commonly differentiated between a subscriber trace (i.e. tracing e.g. of a subscriber's international mobile subscriber identity IMSI) and equipment trace (i.e. tracing e.g. of an international mobile equipment identity IMEI or an international mobile equipment identity software version number IMEISV). Another commonly used differentiation of trace types includes service level trace and traffic trace.

Tracing is suitable to provide for detailed information at call level on one or more specific objects traced. The capability of tracing to log data on any interface at call level for specific objects allows getting information which cannot be obtained e.g. from performance measurements. The data thus collected by a trace may be utilized for monitoring or optimization purposes.

For each trace a trace session is activated, which is a time interval during which trace recording sessions of that particular trace can be executed for collecting trace record information. Generally, a trace is activated from the network management (NM) side, also referred to as the operations support system (OSS) side, i.e. in a conceptual downwards direction. The trace activation can either be a management based trace activation or a signaling based trace activation, both being known as such to a skilled person. Both subscriber traces and equipment traces (or service level traces and traffic traces) are carried out in a subordinate network element or element manager in the network. The data collected (i.e. trace records) is then transferred to an conceptually upper layer of the network such as the network management (NM) or operations support system (OSS) layer for evaluation. In this upper layer, the existing and planned traces as well as the trace records thereof are managed.

Within the concepts and requirements of the trace framework as defined in “3GPP TS 32.421 v7.0.0” of September 2005, two basically different realizations of the communication management architecture are distinguished, referred to as system context A and system context B. In the so-called system context A, the relevant management interface Itf-N is located between a network manager and an element manager, which is conceptually arranged between the network manager and the network element carrying out the tracing and being managed by the element manager. In the so-called system context B, the relevant management interface Itf-N is located between a network manager and a network element carrying out the tracing, wherein the network element has its element manager embedded into itself.

Further details concerning trace session activation and deactivation from the point of view of trace control and configuration management are set out in “3GPP TS 32.422 v6.5.0”, pages 7 to 24, of December 2005, to which reference is made herewith.

From the prior art, it is known that traces are generally activated from the network management side, which also manages the traces activated and to be activated, and which also receives the trace records of the activated traces. Thus, trace configuration data is kept consistent at the network management side.

There is no standardized way of effectively activating a trace session from any other means than the network management, although this is desirable. Such a local activation of a trace in the network would however pose several problems. Such problems are related both to management issues and load control issues.

As regards management issues, these pertain to a consistent and effective trace management. That is, when a trace would be activated remote from the network management, the trace records collected would nevertheless have to be transferred to the network management. Hence, the network management would receive trace records for traces, which have not been activated by the management system and which are thus not registered there. Consequently, no effective control of traces can be achieved any more. Additionally, it would be difficult to manage and locate abandoned traces and to associate information from several network elements, which would be necessary for system level scope and/or the roaming of a traced subscriber/equipment.

As regards load control issues, load on the network management or operations support system may become too high without having a possibility to counter-control. The load in the network elements carrying out the traces may become to high as well as the load on any management interface.

Further issues concerned with these problems are that trace information is sensitive and that trace usage is strictly regulated by law in particular countries.

Accordingly, there is not yet known a solution for effectively handling and managing traces which are not activated by the network management. Thus, an approach to the above problems and drawbacks is needed for providing such a solution.

### SUMMARY OF THE INVENTION

Consequently, it is an object of the present invention to remove the above drawbacks inherent to the prior art and to provide accordingly improved methods, network entities, computer programs and a corresponding system.

According to a first aspect of the invention, this object is for example achieved by a method of trace management in a communication network, the method comprising activating a trace session locally at at least one subordinate network entity; and emitting a notification of said activated trace session from the at least one subordinate network entity to a network managing entity.

According to a second aspect of the invention, this object is for example achieved by a method of trace management in a communication network, the method comprising receiving, at a network managing entity, a notification of a locally activated trace session from at least one subordinate network entity, and managing said activated trace session centrally at said network managing entity

According to further advantageous refinements of the present invention as defined under the above aspect or aspects:

the method further comprises the step of determining at the at least one subordinate network entity, whether said activated trace session is initiated by the network managing entity or the at least one subordinate network entity, wherein the step of emitting a notification is skipped, if it is determined that said activated trace session is initiated by the network managing entity;

the method further comprises the steps of receiving at said network managing entity said notification of an activated trace session from the at least one subordinate network entity; and managing said activated trace session centrally at said network managing entity;

the method further comprises the step of verifying at the network managing entity, upon receipt of said notification, authorization of said activated trace session; and discarding the activated trace session at the subordinate network entity, if said trace session is not authorized according to the verifying step;

the method further comprises the step of checking at the network managing entity, upon receipt of said notification, said activated trace session with respect to at least one predetermined criterion and existing trace sessions, wherein said managing step manages said activated trace session centrally with regard to the result of the checking step;

the at least one predetermined criterion comprises at least one of the following: load on the network managing entity, load on the subordinate network entity, centralized network-level deactivation, and permission in accordance with permissible trace sessions;

the step of managing said activated trace session comprises at least one of the following steps of:
reconfiguring said activated trace session,
deactivating said activated trace session, and
activating said activated trace session additionally at another one of subordinate network entities;

the step of activating a trace session is a signaling based activation or a management based activation;

the at least one subordinate network entity comprises a network element including its element manager, wherein the step of emitting a notification comprises transmitting said notification directly from the at least one subordinate network entity to the network managing entity;

the at least one subordinate network entity comprises a network element and the network further comprises an element manager of the network element which interfaces the subordinate network entity with the network managing entity, wherein the step of emitting a notification comprises the steps of: transmitting said notification from the at least one subordinate network entity to its intermediate element manager; and forwarding said notification from the intermediate element manager to the network managing entity; and/or

the at least one subordinate network entity comprises an element manager of a network element which interfaces the network element managed with the network managing entity, wherein the step of emitting a notification comprises transmitting said notification directly from the at least one subordinate network entity to the network managing entity.

According to a third aspect of the invention, this object is for example achieved by a method of operating a network entity for trace management in a communication network, the method comprising activating a trace session locally at at least one subordinate network entity; and emitting a notification of said activated trace session from the at least one subordinate network entity to a network managing entity.

According to further advantageous refinements of the present invention as defined under the above aspect:

the method further comprises the step of determining at the at least one subordinate network entity, whether said activated trace session is initiated by the network managing entity or the at least one subordinate network entity, wherein the step of emitting a notification is skipped, if it is determined that said activated trace session is initiated by the network managing entity;

the step of activating a trace session is a signaling based activation or a management based activation;

the at least one subordinate network entity comprises a network element including its element manager, wherein the step of emitting a notification comprises transmitting said notification directly from the at least one subordinate network entity to the network managing entity;

the at least one subordinate network entity comprises a network element and the network further comprises an element manager of the network element which interfaces the subordinate network entity with the network managing entity, wherein the step of emitting a notification comprises the steps of: transmitting said notification from the at least one subordinate network entity to its intermediate element manager; and forwarding said notification from the intermediate element manager to the network managing entity; and/or

the at least one subordinate network entity comprises an element manager of a network element which interfaces the network element managed with the network managing entity, wherein the step of emitting a notification comprises transmitting said notification directly from the at least one subordinate network entity to the network managing entity.

According to a fourth aspect of the invention, this object is for example achieved by a method of operating a network managing entity for trace management in a communication network, the method comprising receiving at said network managing entity a notification of a locally activated trace session from the at least one subordinate network entity; and managing said activated trace session centrally at said network managing entity.

According to further advantageous refinements of the present invention as defined under the above aspect:

the method further comprises the step of verifying authorization of said activated trace session; and discarding the activated trace session at the subordinate network entity, if said trace session is not authorized according to the verifying step;

the method further comprises the step of checking said activated trace session with respect to at least one predetermined criterion and existing trace sessions, wherein said managing step manages said activated trace session centrally with regard to the result of the checking step;

the at least one predetermined criterion comprises at least one of the following: load on the network managing entity, load on the subordinate network entity, centralized network-level deactivation, and permission in accordance with permissible trace sessions; and/or

the step of managing said activated trace session comprises at least one of the following steps of:
reconfiguring said activated trace session,
deactivating said activated trace session, and
activating said activated trace session additionally at another one of subordinate network entities.

According to a fifth aspect of the invention, this object is for example achieved by a network entity apparatus for trace management in a communication network, said apparatus comprising a processor (hereinafter referred to as means for activating) configured to activate a trace session locally at said subordinate network entity; and a sender (hereinafter referred to as means for emitting) configured to emit a notification of said activated trace session from said subordinate network entity to a network managing entity, wherein said network entity is subordinate to the network managing entity.

According to further advantageous refinements of the present invention as defined under the above aspect:

the network, further comprises a determinator (hereinafter referred to as means for determining) configured to determine, whether said activated trace session is initiated by the network managing entity or the subordinate network entity, wherein the sender (i.e. the means of emitting a notification) is configured not to emit a notification, if it is determined by the determinator (i.e. the means for determining) that said activated trace session is initiated by the network managing entity;

the network entity is a network element including its element manager, wherein the sender (i.e. the means for emitting a notification) is configured to transmit said notification directly from the network entity to the network managing entity;

the network entity is a network element and the network further comprises an element manager of the network element which interfaces the subordinate network entity with the network managing entity, wherein the sender (i.e. the means for emitting a notification) is configured to carry out the steps of: transmitting said notification from the network entity to its intermediate element manager; and forwarding said notification from the intermediate element manager to the network managing entity; and/or

the network entity is an element manager of a network element which interfaces the network element managed with the network managing entity, wherein the sender (i.e. the means for emitting a notification) is configured to transmit said notification directly from the at least one subordinate network entity to the network managing entity.

According to a sixth aspect of the invention, this object is for example achieved by a network managing entity apparatus for trace management in a communication network, said apparatus comprising a receiver (hereinafter referred to as means for receiving) configured to receive a notification of a locally activated trace session from at least one subordinate network entity; and a manager (hereinafter referred to as means for managing) configured to manage said activated trace session centrally at said network managing entity.

According to further advantageous refinements of the present invention as defined under the above aspect:

the network managing entity further comprises a verifier (hereinafter referred to as means for verifying) configured to verify authorization of said activated trace session, wherein the manager (i.e. the means for managing) is further configured to discard the activated trace session at the subordinate network entity, if said trace session is not authorized by the verifier (i.e. the means for verifying);

the network managing entity further comprises a checker (hereinafter referred to as means for checking) configured to check said activated trace session with respect to at least one predetermined criterion and existing trace sessions, wherein said managing step manages said activated trace session centrally with regard to the result of the checking step; and/or

the manager (i.e. the means for managing said activated trace session) is configured to carry out at least one of the following steps of:
reconfiguring said activated trace session,
deactivating said activated trace session, and
activating said activated trace session additionally at another one of subordinate network entities.

According to a seventh aspect of the invention, this object is for example achieved by a system for trace management in a communication network including a network managing entity apparatus according to the sixth aspect of the invention and at least one subordinate network entity apparatus according to the fifth aspect of the invention.

According to a eighth aspect of the invention, this object is for example achieved by a computer program embodied in a computer-readable medium comprising program code configured to perform trace management in a communication network including a network managing entity and at least one subordinate network entity, the computer program being configured to perform the method according to the first or second aspect of the invention.

According to a ninth aspect of the invention, this object is for example achieved by a computer program embodied in a computer-readable medium comprising program code configured to operate a network entity for trace management in a communication network including a network managing entity and said at least one subordinate network entity, the computer program being configured to perform the method according to the third aspect of the invention.

According to an tenth aspect of the invention, this object is for example achieved by a computer program embodied in a computer-readable medium comprising program code configured to operate a network managing entity for trace management in a communication network including said network managing entity and at least one subordinate network entity, the computer program being configured to perform the steps of the method according to the fourth aspect of the invention.

According to advantageous further refinements of the present invention as defined under any one of the above aspects:

the notification comprises at least one of the following parameters: subordinate network entity identifier of said subordinate network entity activating said trace session, trace activation user name, trace target identifier, trace session identifier, and trace session activation time;

the notification further comprises subordinate network entity identifiers of other subordinate network entities where the trace session has been activated;

the trace target identifier comprises a subscriber identifier of a subscriber to be traced, an equipment identifier of an equipment to be traced, a target object of traffic to be traced, and/or a service identification;

the subscriber identifier comprises a public user identity.

It is an advantage of the present invention that an automated central trace control/management for local trace activation is provided.

It is thus advantageous that a strict control on trace usage in the network management is provided. In case of unnecessary local trace activation, the management system can for example centrally and automatically deactivate an unnecessary logging function.

With the embodiments of the present invention, load control in the network management as well as in the network is enabled.

Furthermore, it is beneficial that the solution according to the present invention improves the functionality of a trace integration reference point (IRP) according to 3GPP standardization.

Another advantage of the present invention resides in that it is also applicable and equally suited when a trace session's configuration parameters are locally changed.

### BRIEF DESCRIPTION OF THE DRAWINGS

In the following, the present invention will be described in greater detail with reference to the accompanying drawings, in which

FIG. 1 shows a flow chart of a method according to an embodiment of the present invention;

FIG. 2 shows a flow chart of a method according to another embodiment of the present invention;

FIG. 3 shows a flow chart of a method according to still another embodiment of the present invention;

FIG. 4 shows a schematic block diagram of a trace management system according to an embodiment of the present invention within system context A;

FIG. 5 shows a schematic block diagram of a trace management system according to another embodiment of the present invention within system context A; and

FIG. 6 shows a schematic block diagram of a trace management system according to an embodiment of the present invention within system context B.

### DETAILED DESCRIPTION OF EMBODIMENTS OF THE PRESENT INVENTION

The present invention is described herein with reference to particular non-limiting examples. A person skilled in the art will appreciate that the invention is not limited to these examples, and may be more broadly applied.

In particular, the present invention is described in relation to telecommunications management network (TMN) terminology. Such terminology is only used in the context of the presented examples, and does not limit the invention in any way.

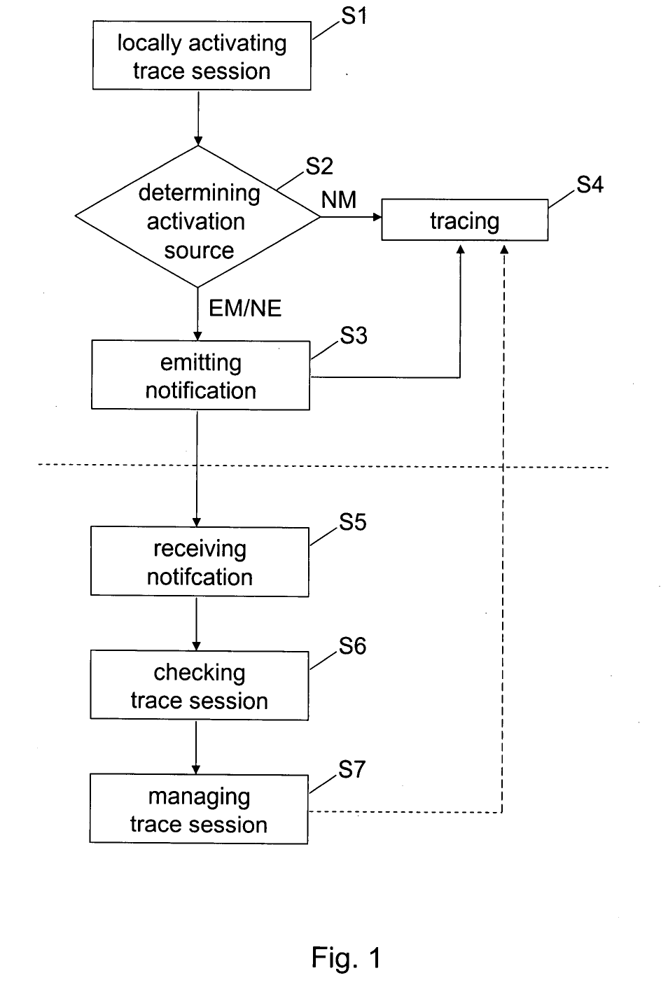

FIG. 1 shows a flow chart of a method according to an embodiment of the present invention. This method relates to a communication network including a network managing entity, hereinafter referred to as network manager NM, and at least one subordinate network entity, hereinafter referred to as element manager or network element depending on the particular system context concerned.

In FIG. 1, the upper half of the method flow above the broken line relates to an operation method of the above-mentioned subordinate network entity, and the lower part of the method flow below the broken line relates to an operation method of the above-mentioned network managing entity.

The method according to FIG. 1 relates a situation where the network entity is generally authorized to activate a trace session locally. Thus, the authorization has not to be verified at the network managing entity.

In step S1 of FIG. 1 a trace session is locally activated at the subordinate network entity (or a trace session's parameters are locally changed). That is to say that this entity, i.e. a network element or an element manager, initiates the trace activation or changes an existing trace session on its own, without being requested by the network manager or any other means. Such a local activation can for example be triggered either locally at the entity or via a remote interface thereto.

When a trace is activated, it is an optional step of the method according to the present embodiment that it is determined at the subordinate network entity, whether the activated trace session has been initiated by the network managing entity or the subordinate network entity itself (step S2). This step serves for minimizing notification overhead in the network.

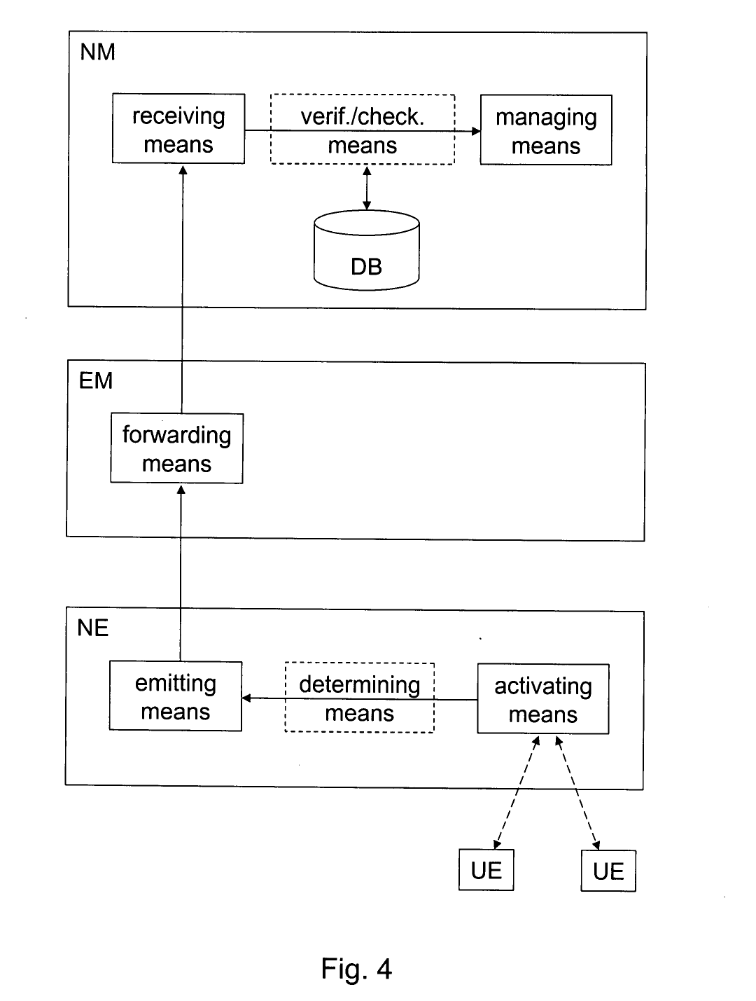

If it is determined in step S2 that the session has been initiated by the subordinate network entity itself, i.e. the element manager EM or the network element NE, the flow proceeds to step S3. Then, a notification is emitted to the network managing entity, which indicates that a trace session has been created. In dependence on the system context concerned the emitting of the notification may either be performed in a direct manner or with an intermediary entity forwarding the notification (cf. FIGS. 4 to 6).

In any case the notification may comprise one or more of the following parameters: a subordinate network entity identifier of the network entity activating the trace session, a trace activation user name, a trace target identifier, a unique trace session identifier, and/or a trace session activation time. In case of a subscriber trace, the trace target identifier comprises a subscriber identifier of a subscriber to be traced. In case of an IP multimedia subsystem (IMS), the subscriber identifier is for example a public user identity. In case of an equipment trace, the trace target identifier comprises an equipment identifier of an equipment to be traced. In case of a traffic trace, also referred to as “multiple MS trace”, the trace target identifier comprises a target object of traffic to be traced. In case of a service level trace, the trace target identifier comprises a service identification.

In case of signaling based trace activation (and particularly, but not exclusively, if the subordinate network entity is an element manager), the notification optionally also comprises a list of network entities or network elements, where the trace session has been activated. This list may also comprise the respective types of network entities or network elements.

One or more of the above-mentioned parameters may be mandatory for the notification, such as e.g. the network entity identifier, the trace session identifier and the trace target identifier.

After emitting the notification or, in case of determination in step S2 that the session has originally been initiated by the network manager NM, the flow proceeds to the actual tracing operation in step S4. This holds true since the network entity, as set out above, is anyway authorized to activate a trace session. The trace operation as such will not be described herein because of not being relevant for the present invention which is rather concerned with trace activation and management.

At the side of the network managing entity, the notification emitted from the subordinate network entity is received in step S5 and thereupon checked in step S6. In step S6, the activated trace session is checked by means of the parameters contained in the respective notification and with respect to predetermined criteria and existing trace session, which are stored e.g. in a local database of the network managing entity. The result of the check of step S6 specifies the kind of operation performed in the subsequent managing step, in which the trace session is managed by the network managing entity in a central manner, step S7 (which in FIG. 1 is indicated by a dashed arrow from step S7 to step S4). Depending on the criteria used for the checking step (for example a load on the network managing entity, a load on the subordinate network entity, a centralized network-level deactivation, security issues and a permission in accordance with a list of permissible trace sessions) the managing step may comprise e.g. an automatic reconfiguration said activated trace session (i.e. a modification of trace parameters) or an automatic deactivation of the currently activated trace session or an automatic activation of the same trace session at one or more other network entities (i.e. copying of the trace session). To this end, the network managing entity according to the present invention is configured to transmit a pre-defined reconfiguration/deactivation/activation message to one or more of subordinate network entities in the network.

For example, the network managing entity may immediately deactivate the current trace session, if it detects that its load is increasing, or because the identity such as the trace session identifier is already used and assigned by the network managing entity to another trace session which is already existing, thus the current identifier being not unique. A copying of the trace session to “neighbor” network elements or element managers of the network entity activating the current trace session for example enables a more complete handover trace routine. The parameter of trace activation user name in the notification may be utilized in order to detect and react on a case of system misuse by a certain user.

According to an alternative implementation of the present embodiment, the network managing entity does not perform the checking step S6, but rather directly proceeds to the managing step S7 upon receipt of the notification. In such a case, the managing operation is based on predefined actions without taking into account any one of the above-mentioned criteria.

Essentially, the method of the present invention is based on an activation of a trace session locally at at least one subordinate network entity and an emission of a notification of said activated trace session from the at least one subordinate network entity to the network managing entity.

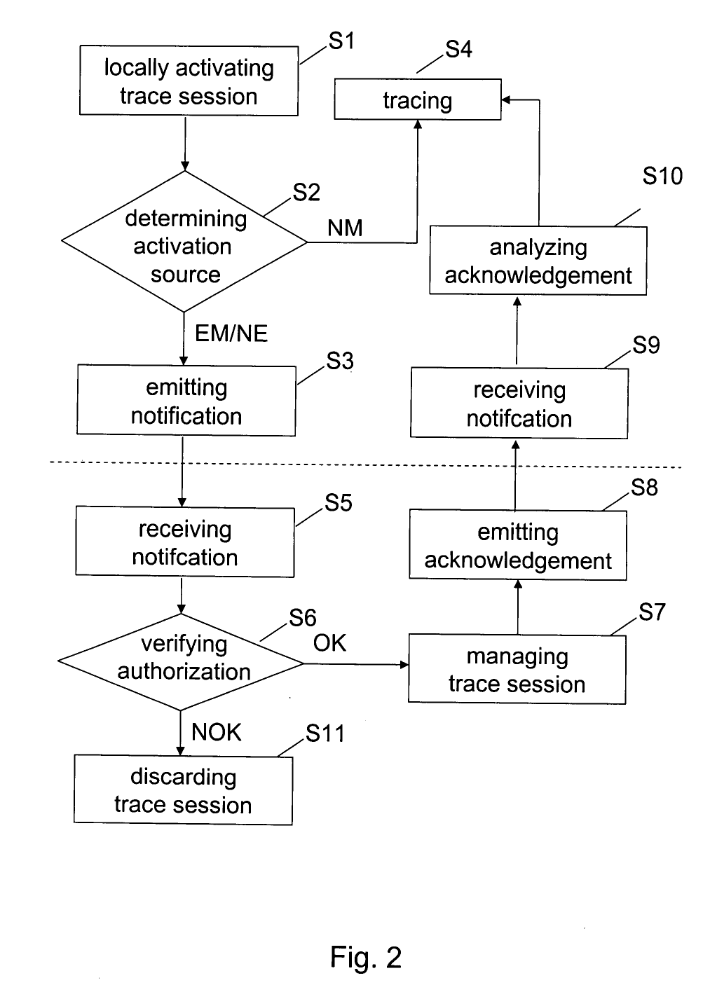

FIG. 2 shows a flow chart of a method according to another embodiment of the present invention. As the present method is similar to that of FIG. 1, only the differences are explained in the following. For further details, reference is made to the description in connection with FIG. 1.

In contrast to the situation underlying FIG. 1, in the present situation the network entity is not generally authorized to activate a trace session locally. The network entity rather initiates a trace session activation, is thereupon ready for a final activation which is pending at that moment, and awaits an acknowledgement from the network managing entity. Thus, the authorization has to be verified at the network managing entity.

Step S1 of the method according to FIG. 2 is thus to be understood as an initiation of a session activation, which has additionally to be acknowledged by the network managing entity. Upon receipt of the notification, the network managing entity verifies the authorization of the activated trace session, i.e. the permission of the network entity to activate this trace session (step S6).

If the result of the verification in step S6 is affirmative (OK in FIG. 2), the flow proceeds to step S7 for managing the trace session. Step S7 of FIG. 2 basically corresponds to step S7 of FIG. 1. Although not shown in FIG. 2, the checking step according to step S6 of FIG. 1 may optionally be performed also in this embodiment, namely between verifying step S6 and managing step S7. Thus, the management of the activated trace session may be based on a verifying result alone or in combination with a checking result.

The trace session management of step S7 proceeds with an emission of an acknowledgement to the network entity (step S8). In this acknowledgement details on activation, deactivation, and/or re-configuration are carried. The acknowledgement is then received and analyzed at the network entity (steps S9 and S10) According to the analyzing result of step S10, the pending tracing operation of step S4 is finally activated.

If the result of the verification in step S6 is negative (NOK in FIG. 2), the flow proceeds to step S11, where the trace session initiation is immediately discarded at the network managing entity. Alternatively a negative acknowledgement may be sent to the network entity (not shown in the figure).

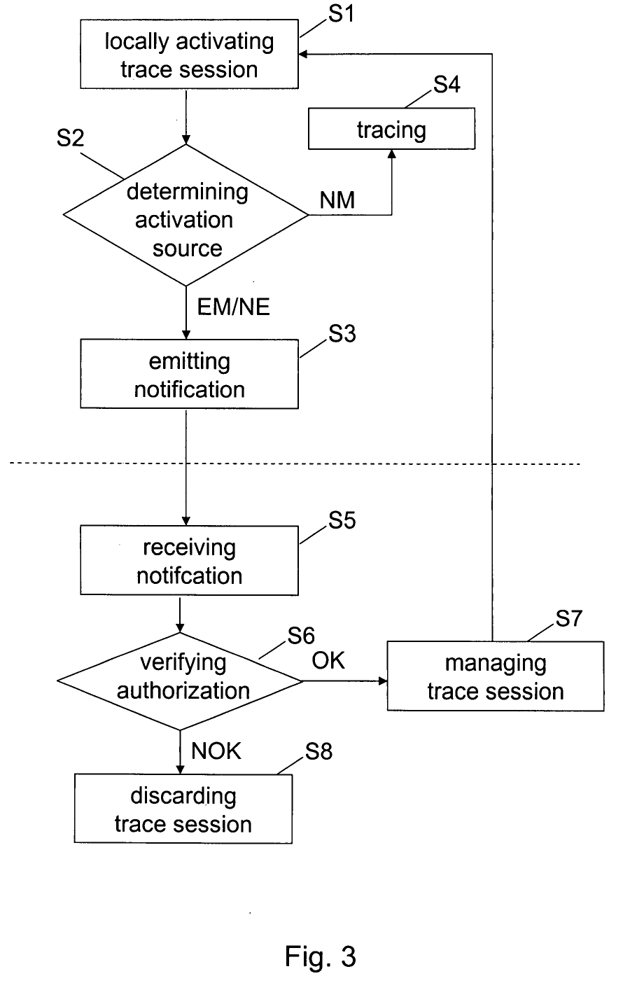

FIG. 3 shows a flow chart of a method according to still another embodiment of the present invention. As the present method is similar to that of FIG. 1, only the differences are explained in the following. For further details, reference is made to the description in connection with FIG. 1.

In contrast to the situation underlying FIG. 1, in the present situation the network entity is not generally authorized to activate a trace session locally. The network entity rather triggers a a trace session activation. That is, the trace session activation at the network entity is to be understood as a “suggestion” for activation a trace session. After emitting a notification with this suggestion (cf. step S3), the network entity does in contrast to the situation of FIG. 2 not keep record of this trace session, i.e. the network entity disregards knowledge of the trace. Thus, after step S1 of FIG. 3, the network entity is not in a ready or pending state, but has triggered the network managing entity to instruct a corresponding trace session activation. Nevertheless, the authorization for locally triggering a trace session has again to be verified at the network managing entity.

As indicated above, step S1 of the method according to FIG. 3 is thus to be understood as a triggering of a session activation, which then has to be instructed by the network managing entity. Upon receipt of the notification, the network managing entity verifies the authorization of the activated trace session, i.e. the permission of the network entity to activate this trace session (step S6).

If the result of the verification in step S6 is affirmative (OK in FIG. 3), the flow proceeds to step S7 for managing the trace session. Step S7 of FIG. 3 basically corresponds to step S7 of FIG. 1. Although not shown in FIG. 3, the checking step according to step S6 of FIG. 1 may optionally be performed also in this embodiment, namely between verifying step S6 and managing step S7. Thus, the management of the activated trace session may be based on a verifying result alone or in combination with a checking result.

In contrast to FIG. 2, the trace session management of step S7 does not directly activate the tracing operation of step S4. Rather, an activation of the trace session is instructed, whereupon the network entity again performs step S1, i.e. the trace is “reactivated”. Thereby, the local activation of step S1 logically originates from the network managing entity, and not from the network entity. Thus, the flow proceeds via step S2 to step S4, where the actual tracing begins.

If the result of the verification in step S6 is negative (NOK in FIG. 3), the flow proceeds to step S8, where the trace session initiation is immediately discarded at the network managing entity.

FIG. 4 shows a schematic block diagram of a trace management system according to an embodiment of the present invention within system context A.

The system of FIG. 4 comprises a network managing entity denoted by NM (for network manager) and two subordinate network entities denoted by EM (for element manager) and NE (for network element) according to the present invention. The element manager EM interfaces the network element NE with the network manager NM. It is to be noted that for the sake of simplicity and by way of example only one network element and element manager are shown, respectively.

The network element of FIG. 4 is operable according to the method in the upper part of FIG. 1. To this end, it comprises activating means, which further comprises an user interface (not shown in the figure), for activating a trace session locally (with respect to at least one user equipment UE) and emitting means for emitting a notification of said activated trace session to the network managing entity NM. A determining means is optionally provided (thus being illustrated in a dashed box) for determining, whether said activated trace session is initiated by the network manager NM or the network element NE. In the present case of system context A, the emitting means is operable not to emit a notification, if it is determined by the determining means that the activated trace session is initiated by the network manager NM. Otherwise, such a notification (with the parameters as set out above) is emitted to the network manager NM, however not in a direct manner. Rather, the emitting means is operable to transmit the notification to its intermediate element manager, wherein the element manager EM comprises forwarding means for forwarding the notification to the network manager NM.

The network manager of FIG. 4 is operable according to the method in the lower part of FIG. 1. To this end, it comprises receiving means for receiving the notification of the activated trace session, optional verifying and/or checking means for, upon receipt of said notification, verifying authorization of the activated trace session and/or checking the activated trace session, and managing means for managing the activated trace session centrally at said network manager, if applicable with regard to the result obtained by the verifying and/or checking means. The verifying/checking means are operable according to step S6 of FIGS. 1, 2 and 3, wherein the verifying and/or checking functionalities are achieved by means of a local database DB. The managing means is operable according to step S7 of FIGS. 1, 2 and 3.

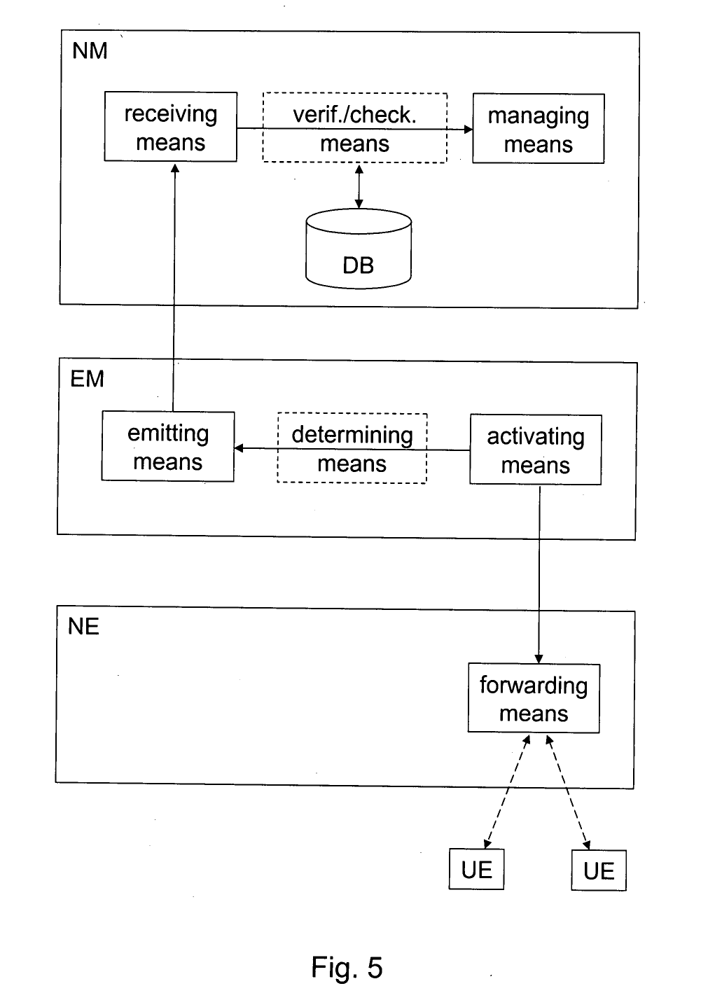

FIG. 5 shows a schematic block diagram of a trace management system according to another embodiment of the present invention within system context A. Again, the element manager EM interfaces the network element NE with the network manager NM. For the sake of simplicity and by way of example again only one network element and element manager are shown, respectively.

The system of FIG. 5 comprises a network managing entity denoted by NM (for network manager) and two subordinate network entities denoted by EM (for element manager) and NE (for network element) according to the present invention. The basic principles of the present embodiment are comparable to those as set out in connection with FIG. 4.

In contrast to the embodiment illustrated in FIG. 4, the element manager EM instead of the network element NE acts as the relevant subordinate network entity. Hence, the element manager EM comprises the activating means, which further comprises an user interface (not shown in the figure), the determining means (optionally) and the emitting means. Yet, these means are operable according to the same principles as set out above.

Basically, two differences result from this fact. First, the activating means does not activate the trace session with respect to at least one user equipment UE in a direct manner, but with the network element NE comprising forwarding means as intermediary entity. Second, the emitting means of the element manager EM is operable to transmit the above-mentioned notification directly to the network manager NM.

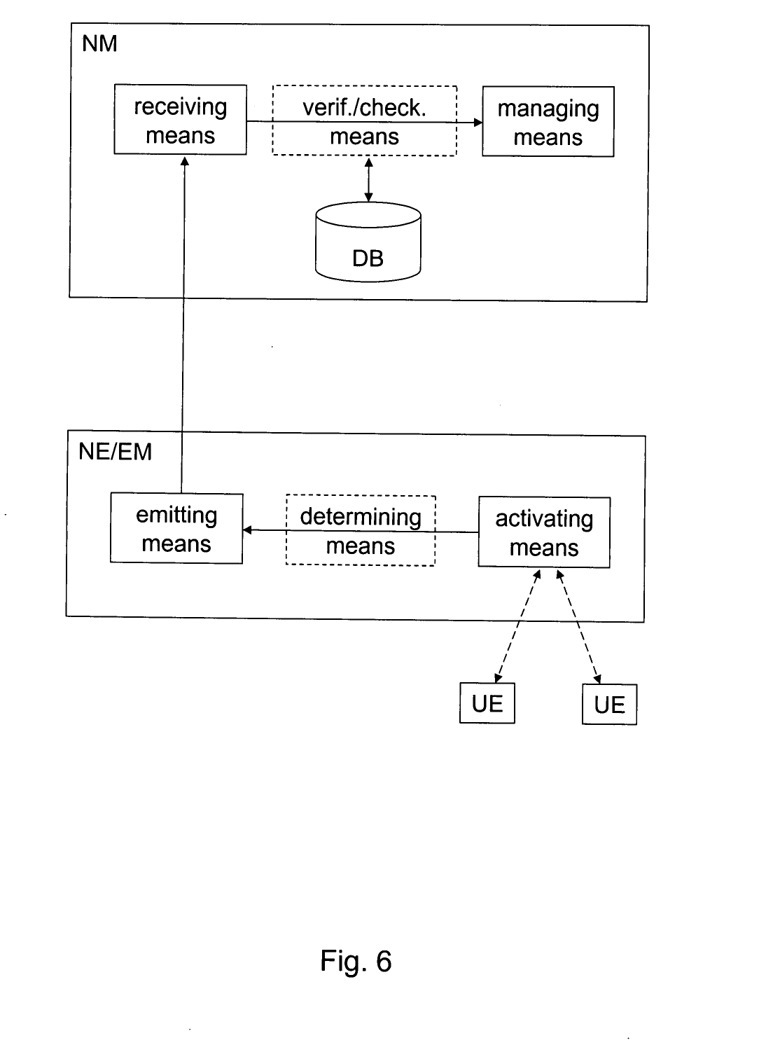

FIG. 6 shows a schematic block diagram of a trace management system according to an embodiment of the present invention within system context B.

The system of FIG. 6 comprises a network managing entity denoted by NM (for network manager) and a subordinate network entity denoted by NE/EM (for network element/element manager) according to the present invention. Apart from the difference that the network element embeds its own element manager (which is characteristic for system context B), the basic principles of the present embodiment are comparable to those of FIGS. 4 and 5. For the sake of simplicity and by way of example only one network element including its element manager is shown.

On the one hand, like in the embodiment illustrated in FIG. 4, the network element (here including its element manager) comprises the activating means, the determining means (optionally) and the emitting means. Again, these means are operable according to the same principles as set out above.

On the other hand, comparable to the embodiment illustrated in FIG. 5, the emitting means of the network element (here including its element manager) is operable to transmit the above-mentioned notification directly to the network manager NM.

Accordingly, the embodiments of the present invention generally cover all cases of trace activation being initiated by a network element or an element manager thereof, irrespective of the underlying network architecture or system context.

With reference to any one of FIGS. 4 to 6, subject to the kind of network concerned, the network element is for example a radio network controller RNC (for a radio access network such as UTRAN), a serving GPRS support node SGSN or a gateway GPRS support node GGSN or a broadcast/multicast service center BM-SC (for a packet-switched core network domain), a mobile switching center MSC (for a circuit-switched core network domain), a serving call session control function S-CSCF or a proxy call session control function P-CSCF (for an IP multimedia subsystem IMS) or the like.

Stated in more general terms, the network entities and the system comprised of the network entities of FIGS. 4 to 6 are configured to perform any of the methods of trace management as described throughout this description and/or the claims. According to another embodiment of the present invention, this could also be accomplished by respective computer program products being loadable into a memory of a digital processing means of a network entity in a communication system and comprising software code portions for performing a respective method, when said product is run on said digital processing means. Accordingly, the present invention involves corresponding computer programs for a (subordinate) network entity, a network managing entity and an overall system, respectively.

In general, it is also to be noted that the mentioned functional elements, e.g. activating means or managing means according to the present invention can be implemented by any known means, either in hardware and/or software, respectively, if it is only adapted to perform the described functions of the respective parts. For example, the activating means of the subordinate network entity can be implemented by any data processing unit, e.g. a microprocessor, being configured to locally activate a trace session as defined by the appended claims. The mentioned parts can also be realized in individual functional blocks or by individual devices, or one or more of the mentioned parts can be realized in a single functional block or by a single device. Correspondingly, the above illustration of FIGS. 4 to 6 is only for illustrative purposes and does not restrict an implementation of the present invention in any way.

Furthermore, method steps likely to be implemented as software code portions and being run using a processor at one of the entities are software code independent and can be specified using any known or future developed programming language such as e.g. C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

According to the present invention and its embodiments, there is presented an automated central trace management in a communication network including a network managing entity and at least one subordinate network entity, comprising the steps of activating a trace session locally at the at least one subordinate network entity and emitting a notification of said activated trace session from the at least one subordinate network entity to the network managing entity.

In summary, according to the present invention the trace management and managing trace sessions as well as load control can be done in a centralized manner at the network management layer, irrespective of where the trace sessions are activated or where a trace session's configuration parameters are changed. Hence, a trace application ensuring an overall control of traces from every aspect is practicable to be build in the management systems of networks, even though trace activation is done locally at a network element side or an element manager side. Thereby, the network management layer keeps the control of trace management in the whole network.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed in the appended claims.

What is claimed is:

1. A method of trace management in a communication network, the method comprising:
activating a trace session locally at at least one subordinate network entity; and
emitting a notification of said activated trace session from the at least one subordinate network entity to a network managing entity.

2. The method according to claim 1, wherein said notification comprises at least one of the following parameters:
subordinate network entity identifier of said subordinate network entity activating said trace session,
trace activation user name,
trace target identifier,
trace session identifier, and
trace session activation time.

3. The method according to claim 2, wherein said notification further comprises:
subordinate network entity identifiers of other subordinate network entities where the trace session has been activated.

4. The method according to claim 2, wherein the trace target identifier comprises a subscriber identifier of a subscriber to be traced.

5. The method according to claim 2, wherein the trace target identifier comprises an equipment identifier of an equipment to be traced.

6. The method according to claim 2, wherein the trace target identifier comprises a target object of traffic to be traced.

7. The method according to claim 2, wherein the trace target identifier comprises a service identification.

8. The method according to claim 1, further comprising:
determining, at the at least one subordinate network entity, whether said activated trace session is initiated by the network managing entity or the at least one subordinate network entity,
wherein emitting a notification is skipped, if it is determined that said activated trace session is initiated by the network managing entity.

9. The method according to claim 1, further comprising:
discarding the activated trace session at the subordinate network entity, if said trace session is not authorized.

10. A method of trace management in a communication network, the method comprising:
receiving, at a network managing entity, a notification of a locally activated trace session from at least one subordinate network entity; and
managing said activated trace session centrally at said network managing entity.

11. The method according to claim 10, wherein said notification comprises at least one of the following parameters:
subordinate network entity identifier of said subordinate network entity activating said trace session,
trace activation user name,
trace target identifier,
trace session identifier, and
trace session activation time.

12. The method according to claim 11, wherein said notification further comprises:
subordinate network entity identifiers of other subordinate network entities where the trace session has been activated.

13. The method according to claim 11, wherein the trace target identifier comprises a subscriber identifier of a subscriber to be traced.

14. The method according to claim 11, wherein the trace target identifier comprises an equipment identifier of an equipment to be traced.

15. The method according to claim 11, wherein the trace target identifier comprises a target object of traffic to be traced.

16. The method according to claim 11, wherein the trace target identifier comprises a service identification.

17. The method according to claim 10, further comprising:
verifying, at the network managing entity, upon receipt of said notification, authorization of said activated trace session.

18. The method according to claim 10, further comprising:
checking, at the network managing entity, upon receipt of said notification, said activated trace session with respect to at least one predetermined criterion and existing trace sessions,
wherein said managing process manages said activated trace session centrally with regard to the result of the checking process.

19. The method according to claim 18, wherein the at least one predetermined criterion comprises at least one of the following:
load on the network managing entity,
load on the subordinate network entity,
centralized network-level deactivation, and
permission in accordance with permissible trace sessions.

20. The method according to claim 18, wherein the managing said activated trace session comprises at least one of the following:
reconfiguring said activated trace session,
deactivating said activated trace session, and
activating said activated trace session additionally at another one of subordinate network entities.

21. A method of operating a network entity for trace management in a communication network, the method comprising:
activating a trace session locally at at least one subordinate network entity; and
emitting a notification of said activated trace session from the at least one subordinate network entity to a network managing entity.

22. The method according to claim 21, further comprising:
determining, at the at least one subordinate network entity, whether said activated trace session is initiated by the network managing entity or the at least one subordinate network entity,
wherein the process of emitting a notification is skipped, if it is determined that said activated trace session is initiated by the network managing entity.

23. A method of operating a network managing entity for trace management in a communication network, the method comprising:
receiving, at a network managing entity, a notification of a locally activated trace session from at least one subordinate network entity; and
managing said activated trace session centrally at said network managing entity.

24. The method according to claim 23, further comprising:
verifying, at the network managing entity, upon receipt of said notification, authorization of said activated trace session.

25. The method according to claim 23, further comprising:
checking, at the network managing entity, upon receipt of said notification, said activated trace session with respect to at least one predetermined criterion and existing trace sessions,
wherein said managing process manages said activated trace session centrally with regard to the result of the checking process.

26. The method according to claim 23, wherein the managing said activated trace session comprises at least one of the following:
reconfiguring said activated trace session,
deactivating said activated trace session, and
activating said activated trace session additionally at another one of subordinate network entities.

27. A network entity apparatus comprising:
a processor configured to activate a trace session locally at said network entity; and
a sender configured to emit a notification of said activated trace session from said network entity to a network managing entity, wherein said network entity is subordinate to the network managing entity.

28. The network entity apparatus according to claim 27, wherein said sender is configured to emit a notification comprising at least one of the following parameters:
subordinate network entity identifier of said subordinate network entity activating said trace session,
trace activation user name,
trace target identifier,
trace session identifier, and
trace session activation time.

29. The network entity apparatus according to claim 27, further comprising:
a determinator configured to determine, whether said activated trace session is initiated by the network managing entity or the subordinate network entity,
wherein the sender is configured not to emit a notification, if it is determined by the determinator that said activated trace session is initiated by the network managing entity.

30. The network entity apparatus according to claim 27, wherein said processor is further configured to discard the activated trace session, if said trace session is not authorized.

31. A network managing entity apparatus comprising:
a receiver configured to receive a notification of a locally activated trace session from at least one subordinate network entity; and
a manager configured to manage said activated trace session centrally at said network managing entity.

32. The network managing entity apparatus according to claim 31, further comprising:
a verifier configured to verify, upon receipt of said notification by said receiver, authorization of said activated trace session,
wherein the manager is further configured to discard the activated trace session, if said trace session is not authorized by the verifier.

33. The network managing entity apparatus according to claim 31, further comprising:
a checker configured to check said activated trace session with respect to at least one predetermined criterion and existing trace sessions,
wherein said manager is further configured to manage said activated trace session centrally with regard to the result of the checker

34. The network managing entity apparatus according to claim 33, wherein the manager is configured to carry out at least one of the following:
reconfiguring said activated trace session,
deactivating said activated trace session, and
activating said activated trace session additionally at another one of subordinate network entities.

35. A system comprising
a subordinate network entity apparatus comprising:
a processor configured to activate a trace session locally at the at least one subordinate network entity; and
a sender configured to emit a notification of said activated trace session from said subordinate network entity to a network managing entity, and
a network managing entity apparatus comprising:
receiver configured to receive a notification of a locally activated trace session from the at least one subordinate network entity;
a checker configured to check, upon receipt of said notification, said activated trace session with respect to at least one predetermined criterion and existing trace sessions; and
manager configured to manage said activated trace session centrally at said network managing entity with regard to the result obtained by said means for checking.

36. A computer program product embodied in a computer-readable medium having encoded thereon a program code configured to operate a network entity for trace management in a communication network, the computer program being configured to perform:
activating a trace session locally at at least one subordinate network entity; and
emitting a notification of said activated trace session from the at least one subordinate network entity to a network managing entity.

37. A computer program product embodied in a computer-readable medium having encoded thereon a program code configured to operate a network managing entity for trace management in a communication network, the computer program being configured to perform:
receiving, at a network managing entity, a notification of an activated trace session from at least one subordinate network entity; and
managing said activated trace session centrally at said network managing entity.

38. A computer program product embodied in a computer-readable medium having encoded thereon a program code configured to perform trace management in a communication network,
the computer program being configured to perform at at least one subordinate network entity:
activating a trace session locally at the at least one subordinate network entity; and
emitting a notification of said activated trace session from the at least one subordinate network entity to a network managing entity, and
the computer program being configured to perform at said network managing entity the steps of:
receiving a notification of an activated trace session from the at least one subordinate network entity; and
managing said activated trace session centrally at said network managing entity.
